(19) United States
(12) Patent Application Publication
(10) Pub. No.: US 2023/0038755 A1
(43) Pub. Date: Feb. 9, 2023

(54) SYSTEM AND METHOD FOR IMPROVING FAIRNESS AMONG JOB CANDIDATES

(71) Applicant: HIREDSCORE INC., NEW YORK, NY (US)

(72) Inventors: SHLOMY BOSHY, NES ZIONA (IL); RACHEL ATHENA KARP, NEW YORK, NY (US)

(21) Appl. No.: 17/392,441

(22) Filed: Aug. 3, 2021

(51) Int. Cl. G06Q 10/10

(52) U.S. Cl. CPC G06Q 10/1053

(57) ABSTRACT

Removing bias when matching job candidates to open positions by obtaining candidates’ data including information about the job candidates and a likelihood rate that the candidate matches the open position, identifying protected characteristics from the candidates’ data, generating a training data set that does not bias within groups of candidates having different protected characteristics, where the training data set includes a portion of the job candidates, training a model based on the training data set, applying the trained model on a test set, where the test set is different from the training data set, and determining a fairness measurement value of the trained model using the results of the model on the test set and protected characteristics of candidates of the test set.

### FIELD

The present invention relates to computerized processes that improve employee recruitment.

### BACKGROUND

Hiring the right employees is one of the biggest challenges for every organization, from a grocery store to multi-national organizations. Larger organizations naturally hire more employees, and receive a large number of resumes for jobs. The resumes may be received via email, or via other platforms, mainly digital platforms that send the resumes over the internet, for example via the organizations’ career website.

Large corporations employ teams that review the huge number of resumes for each job, filter the job candidates and decide which candidates move to the next recruiting phase, usually interviews (which can include face-to-face interviews, phone screens, or video interviews).

One of the challenges these organizations face is ensuring fair / unbiased / compliant matching of candidates to job positions when hiring candidates. The bias can be based on gender, for example when preferring men over women or vice versa, based on age, ethnicity, disabilities or any other characteristics which is not professional or not substantial. In the USA, organizations that employ using biased methods may be exposed to civil complaints. In addition, biased hiring may negatively impact the organization’s image and perception.

Usually, data inputted into a recruiting software by recruiters include grades for candidates, indicating the level in which the recruiters consider the candidates to match an open position. These grades can be biased, when recruiters may prefer, even seamlessly, candidates of some groups, as these groups are defined by protected characteristics. For example, recruiters may seamlessly prefer one ethnicity group over another ethnicity group, or by preferring candidates from background and socioeconomic classes similar to their own or the majority of the members of the team they joining.

When training a computerized engine, for example a classifier, to avoid bias, the input for the classifier is the recruiter’s decisions about candidates, which we can sum up into employment rate divided by groups. For example, a specific organization hires 60% of the white candidates and 25% of the black candidates. The classifier uses this input to predict whether or not a new candidate matches a job position in the organization.

Challenges to face the unbiased matching of candidates with job openings were focused on a process of parsing the jobs and resumes and improving the software-based model that computes a matching score for a job candidate. However, these processes focused on an output of the model and the results of this model remained biased - meaning the model may over-recommend people belonging to one race or gender over another.

### SUMMARY

The invention, in embodiments thereof, provides methods for ensuring fair / unbiased / compliant matching of candidates or internal employees to job positions when hiring candidates to positions using an automatic matching learning-based hiring process. The methods include an algorithm for processing the candidates’ data and a validation process to validate the fairness of the algorithm results.

This method ensures fairness in the algorithm without changing the algorithm itself (e.g., without changing the loss function of the algorithm) by a data preprocessing process which removes the biases from the training set for the algorithm. The algorithm may be a model based of machine learning that receives an unbiased training data set and learns from the training data set how to evaluate candidates in an unbiased manner.

In other embodiments of the invention, a computerized method is provided for removing bias when matching job candidates to open positions, the method comprising obtaining candidates’ data comprising information about the job candidates and a likelihood rate that the candidate matches the open position, identifying protected characteristics from the candidates’ data, generating a training data set that does not bias within groups of candidates having different protected characteristics, wherein the training data set comprises a portion of the job candidates, training a model based on the training data set, applying the trained model on a test set, wherein the test set is different from the training data set, determining a fairness measurement value of the trained model using the results of the model on the test set and protected characteristics of candidates of the test set.

In some cases, the method further comprising computing a number of negative examples to be removed from the candidate’s data when creating the training data set. In some cases, the number of negative examples is computed to substantially equal grades between the groups of candidates defined by the protected characteristics. In some cases, the number of negative examples is computed to substantially equal positive rates among the groups of candidates defined by the protected characteristics, wherein the positive rates define that the candidate is likely to match to the open position. In some cases, the positive rates among groups differ in a value lower than a predefined threshold.

In some cases, the method further comprising defining groups of the candidates based on the extracted protected features. In some cases, the method further comprising enriching the candidates’ data by adding features to the candidates’ data. In some cases, the protected characteristics comprise at least one of a group comprising age, gender, ethnicity, disabilities and a combination thereof.

In some cases, determining a fairness measurement value of the trained model further comprising providing grades to the candidates’ applications in the test set, dividing the candidates’ application in the test set to groups according to the protected characteristics, applying a statistical test of difference in % of the grades among the groups. In some cases, determining a fairness measurement value of the trained model further comprising removing confounders effect from the test set.

In another aspect of the invention, a system is provided for removing bias when matching job candidates to open positions, the system comprising a memory and at least one electronic processor that executes instructions to perform actions comprising: obtaining candidates’ data comprising information about the job candidates and a likelihood rate that the candidate matches the open position, identifying protected characteristics from the candidates’ data, generating a training data set that does not bias within groups of candidates having different protected characteristics, wherein the training data set comprises a portion of the job candidates, training a model based on the training data set, applying the trained model on a test set, wherein the test set is different from the training data set, determining a fairness measurement value of the trained model using the results of the model on the test set and protected characteristics of candidates of the test set.

In some cases, the actions further comprise providing grades to the candidates’ applications in the test set, dividing the candidates’ application in the test set to groups according to the protected characteristics, applying a statistical test of difference in % of the grades among the groups.

In some cases, the actions further comprise computing a number of negative examples to be removed from the candidate’s data when creating the training data set. In some cases, the number of negative examples is computed to substantially equal grades between the groups of candidates defined by the protected characteristics. In some cases, the number of negative examples is computed to substantially equal positive rates among the groups of candidates defined by the protected characteristics, wherein the positive rates define that the candidate is likely to match to the open position. In some cases, the positive rates among groups differ in a value lower than a predefined threshold.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method of ensuring fair and unbiased matching of candidates to positions, according to exemplary embodiment of the present invention.

FIG. 2 shows a method of processing candidates’ data when matching candidates to positions, according to exemplary embodiment of the present invention.

FIG. 3 shows a method of evaluating a model for matching candidates to positions, according to exemplary embodiment of the present invention.

### DETAILED DESCRIPTION

The invention, in embodiments thereof, reduces bias when hiring employees, and when predicting the likelihood that a certain job candidate will match a job position in an organization. Prior art recruiting processes used data inputted into a recruiting software by recruiters. The data inputted by the recruiters define how much a candidate matches an open position, for example based on the candidates’ resume vs the position’s requirements. This data can be biased, as recruiters may prefer, even seamlessly, one group over another group, for example by preferring one ethnicity group over another ethnicity group, or by preferring candidates in an age range closer to the recruiter’s age.

When training a computerized engine, for example a classifier, to avoid bias, the input for the classifier is the recruiter’s data about candidates, or employment rate divided by groups. The rate of the positive grades is likely to be different among groups. For example, a specific organization hires 60% of the white candidates and 25% of the black candidates. The different positive rates of groups divided by protected characteristics are inserted as input into the algorithm, effects the model’s decisions and create bias in the algorithm’s output. The classifier uses this input to predict whether or not a new candidate matches a job position in the organization. This way, if the classifier receives as input the candidate’s “ethnicity”, the classifier will “learn” that when the candidate’s ethnicity is White, it’s more likely that the candidate will be hired. Then, the classifier will mimic the recruiter’s bias into the algorithm. The classifier uses the ethnicity/age characteristic of the candidates because it helps predicting hiring, because the positive rate is different between the groups (60% vs 30%). So, when the classifier obtains the candidates’ ethnicity, the classifier can use it in predicting predict if the candidate will be hired or not, thus creating a bias. Even if the specific ethnicity is not used as input to the algorithm, the algorithm can “learn” from the bias in the inputs from other non-job-related features correlated to ethnicity.

Embodiments of the invention described herein avoid the recruiter’s bias by generating a balanced train set and training the classifier using the balanced train set. In the balanced train set, the positive rates (or other statistical properties) of different groups are the same (e.g., both Black and White are hired 60% of the time). As a result, the classifier does not have any advantage in predicting hiring using ethnicity or any other protected characteristic or non-job-related features correlated to the protected characteristic, and the human bias is removed from the training data. This way, the decision predicting the candidates’ matching to a job position can be based only on job related criteria. In addition, embodiments of the invention described herein disclose evaluating, after training and testing, that there is no statistically significant difference between the grades provided to candidates among different groups of protected characteristics, or between the percentage of “high grades” between the groups. Embodiments of the invention described herein also disclose processes for generating a training set having similar subsets other than “positive rates” among different groups of protected characteristics. Such subsets may comprise negative rates, averaged candidates, exceptionally good candidates, exceptionally irrelevant candidates and the like. Other subsets or functions derived from the candidates’ data can be added by a person skilled in the art when generating the unbiased training set. Embodiments of the invention described herein disclose a computerized system and method for ensuring fair and/or unbiased matching of candidates to job positions when hiring candidates to positions using automatic matching learning based hiring processes. The method comprises obtaining candidates’ data and generating a training set for a learning model. The training set is unbiased by protected characteristics, such as gender, ethnicity, age and other characteristics that are not related to the candidate’s likelihood to perform the job or meet job description requirements. The protected characteristics differ from job-related characteristics, such as experience, education, skills, volunteering experience and the like. Then, the model is applied using a second group of candidates’ data and the fairness measurement of the model is evaluated according to the difference between the model’s output compared to properties of a test set which was not used to train the model.

This way, the process provides both a processing method for the candidates’ data and a validation method for fairness of the model’s results. The method allows to ensure fairness in an algorithm without changing the algorithm itself (e.g., without changing the loss function of the algorithm) just by a data preprocessing method which removes the biases from the training set for the algorithm.

The term “job candidate” refers to a person sending a message or a request informing an organization that the person wishes to be employed in a specific job, or in multiple relevant jobs in the organization. The method can be used also in other cases when the candidate did not apply to ensure fairness of hiring or for considering internal employees into new positions in the organization.

The term “training” - refers to a process in which a machine learning algorithm is created using an input training set with examples. The output is a model that can predict the match of a candidate to a job when both are given as new inputs to the model.

The term “fairness” is defined as giving substantially the same “grades” to candidates with the same job-related and/or professional abilities regardless of their group (gender/race/disabilities etc.). One example of a method to compare grades distribution, which is used in assessment tests evaluation is to compare the percentage of “good grades” in each group and ensure there is no statistically significant difference between the groups in this measure.

Fairness is achieved when the grades / percentage of good grades of different groups are not statistically significantly different between groups. Fairness can also be interpreted as having non statistically significantly different grades distributions for groups of candidates, not only to persons.

The term “bias” refers to a statistically significant difference between the percentage of good grades in different groups OR the distribution of the grades in different groups that is associated with the protected features (e.g., by gender / ethnicity of the candidates) which cannot be explained by job-related differences between the groups candidates.

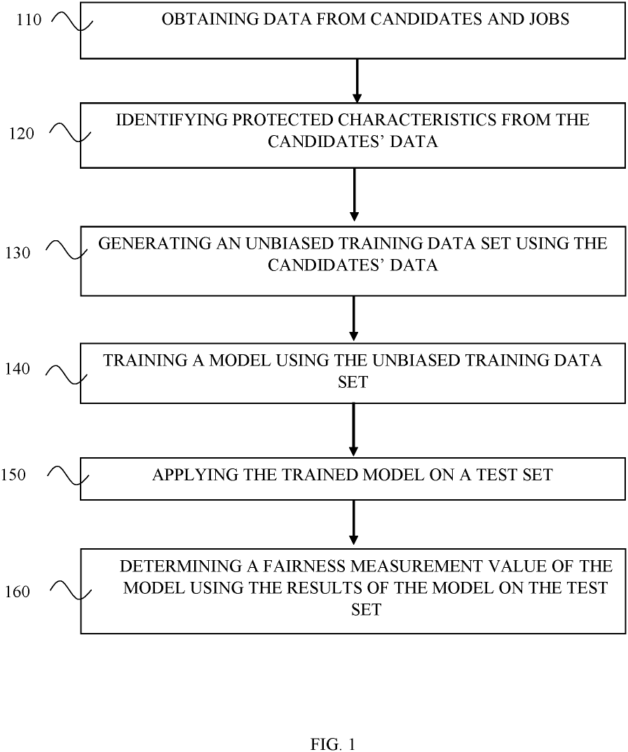

FIG. 1 shows a method of ensuring fair and unbiased matching of candidates to positions, according to exemplary embodiment of the present invention.

Step 110 discloses obtaining candidates’ data and open positions. The candidates’ data can be provided from Application Tracking System (Client), CRM systems, employees data, from dedicated websites 3rd party candidate pools and the like. The candidates’ data may comprise structured resumes or unformatted information inputted into a document or even images of resumes or a person’s past project or any other way to understand candidate abilities. The candidates’ data may comprise data fields filled by the candidate or by another person or computerized entity. The data fields may be provided in addition to the resume, or instead of the resumes. For example, a data source with job requirements/descriptions and candidate abilities/resumes and a positive/negative decision on the candidate match to the requirements (or a multi-level or continuous grade given by humans to this match).

Step 120 discloses identifying protected characteristics from candidates’ data. The protected characteristics include the candidates’ age, gender, religion, ethnicity, disabilities and the like. The protected characteristics may be identified after parsing the candidates’ data. The identification can be based on receiving specific data fields and values for the characteristics. The identification may be based on any other method to receive the protected characteristic values for each training and test examples.

Step 130 discloses generating an unbiased training data set. The training data set does not bias within groups of candidates. The groups are defined according to one or more protected characteristics. Each of the protected characteristics has multiple groups. For example, the protected characteristics “gender” might be divided to the following groups: “women”, “men”. The protected characteristics “ethnicity” might be divided to the following groups: “Black”, “Hispanic”, “Native American” and the like. The training set is unbiased in the sense that the data set includes groups having similar positive rates. The rates can be calculated using past recruiters decisions data. This is the rate of candidates being considered positive by recruiters. The target is that the output balanced train set will have similar positive rates in all groups.

In some cases, the training set is further defined as having similar number of “positive candidates” in each group. That is, in addition to having substantially equal positive rates in each group, the number of candidates in each group is substantially the same. This may be achieved by removing candidates from groups. For example, in case the candidates’ data has 800 male candidates and 350 female candidates, the software will remove about 450 male candidates, while maintaining substantially equal positive rates for the group of male candidates and female candidates. The same process may be performed on groups defined by ethnicity. For example, female candidates of Hispanic origin will have substantially equal positive rate as female candidates of black origin, as well as male candidates of native American origin.

Step 140 discloses training a model using the unbiased training set. The training outputs a software algorithm that predicts the likelihood that a candidate matches a job position regardless to the protected characteristics. That is, according to the software generated by the model using the unbiased training set, a white person will not receive a grade higher or lower than a black candidate when both have the same abilities, given the job requirements.

Step 150 discloses applying the trained model on a test set. The test set is different from the training data set. The trained model receives candidates’ data and outputs a matching or relevance score to the candidates for a specific job, or for a group of jobs.

Step 160 discloses determining a fairness measurement value of the model using the results of the model on the test set. The fairness measurement measures whether or not the model assigned different grades to groups of candidates according to the protected characteristics.

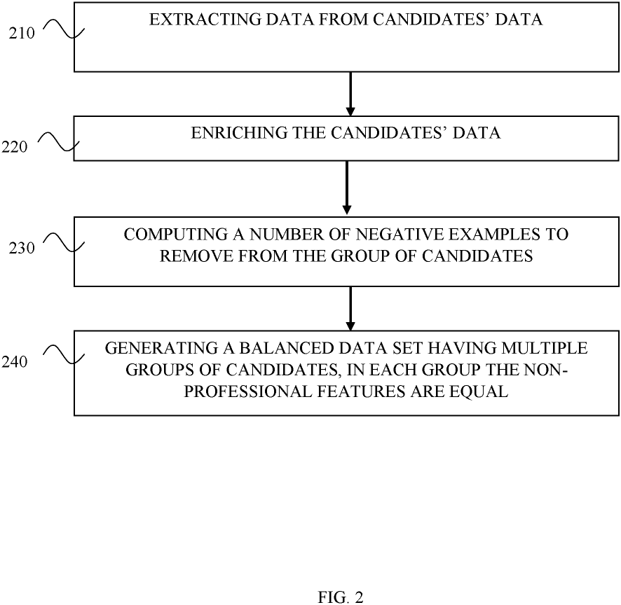

FIG. 2 shows a method of processing candidates’ data when matching candidates to positions, according to exemplary embodiment of the present invention.

Step 210 discloses extracting data from candidates’ data. The data may be extracted using parsing, or using another process desired by a person skilled in the art. The data may be from job-related characteristics, such as experience, education, skills, volunteering experience and the like. The data may be data related to protected characteristics, such as age, gender, ethnicity, religion, disabilities and the like.

Step 220 discloses enriching the candidates’ data. The data enrichment process may comprise adding features to the candidates’ data, such as profession, candidates’ seniority, candidates’ relevance to the job requirements, computing a distance between the candidate’s data and job’s requirement and the like.

Step 230 discloses computing the number of negative examples to remove from the group of candidates to achieve a balanced training set. Assuming the candidates’ data comprises K groups in the data set, each group has a positive rate defining the positive grades of candidates in the group. The maximum positive rate among all groups is obtained when comparing the positive rate of each group. In order to compare the positive rates of each group, a number of negative examples are removed from the groups. In each group, the process is to compute a specific positive rate, for example by computing a function of [positive candidates/ (positive candidates + negative candidates)]. When the number of positive candidates and negative candidates is known, as well as the target positive rate for all the groups, the process computes the number of “required negative candidates”. For example, in case the target positive rate is 0.75 and there are 12 positive candidates and 12 negative candidates, the output of this process will be to remove 8 negative candidates, such that 12/ (12+4) =0.75.

Step 240 discloses outputting a balanced data set having multiple groups of candidates, the groups are defined by protected characteristics. In each group, a subset of grades is substantially equal. The grades may be “positive grades”, “negative grades”, “averaged grades” and the like. The grades refer to the likelihood that a certain job candidate will match a job position in an organization. The output may be sent to the model over the internet. The balanced data set may be stored at a server accessible to the model.

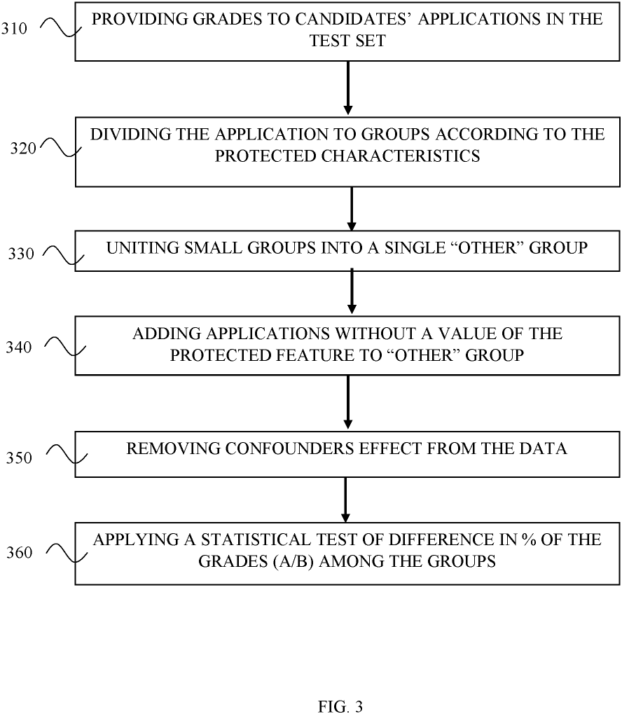

FIG. 3 shows a method of evaluating a model for matching candidates to positions, according to exemplary embodiment of the present invention.

Step 310 discloses providing grades to candidates’ applications in the test set. The grades are provided by the trained model, as trained according to the unbiased training data set. The model assigns grades indicating a likelihood that a certain job candidate will match a specific job position in the organization. The model provides grades to the candidates that apply to job positions during a specific time period, or a specific section in the organization. The grades may be selected from a closed group. For example, the grades may be A/B/C/D when A/B are high grades and C/D are low grades. The grades represent the candidate’s match to the job.

Step 320 discloses dividing the candidates’ application in the test set to groups according to the protected characteristics. The test set contains the protected characteristics, which are extracted from the text assembling the test set. In some cases, the groups are defined by a single protected characteristics (age/gender/ethnicity) or a combination of protected characteristics. In the latter, group #1 may comprise male of white ethnicity, group #2 may comprise male of Hispanic ethnicity, group #3 may comprise male of black ethnicity, group #4 may comprise female of white ethnicity, group #5 may comprise male of black ethnicity and group #6 may comprise male of Hispanic ethnicity,

Step 330 discloses uniting small groups into a single “other” group. The small groups comprise a number of candidates smaller than a predefined threshold, or a predefined percentage from the candidates in the test set.

Step 340 discloses adding applications without a grade of the protected characteristics to “other” group. The “other” group contains the candidates who did not provide data concerning the protected characteristic. The method may comprise verifying that the “other” group is not different than the other groups defined by protected characteristics.

Step 350 discloses removing confounders effect from the test set. The motivation to remove the confounders effect is that differences in percentage of good grades in groups defined by the protected characteristics can be a result of differences in the inputs. For example, male candidates can have different distribution of years of experience relative to female candidates. Since some jobs require a minimal number of years of experience to get a good grade - male may have a higher percentage of good grades, not because of bias.

The process for removing confounders effect from the test set may be implemented as detailed below. Other methods for removing the removing confounders selected by a person skilled in the art are also contemplated by embodiments of the invention. The process comprises dividing the candidates to sections by job-related feature values. Then, selecting the same number of candidates having the same protected characteristics in a section. Then, creating a new data set in which the candidates having different protected characteristics are distributed similarly among the sections defined by job-related feature values.

Step 360 discloses applying a statistical test of difference in % of the grades (A/B) among the groups. This process comprises computing, for each group defined by protected characteristics, the number of applications in the group with good (A/B) grades and the number of applications having bad (C/D) grades. This process can be alternated with any other method to divide grades into good and bad groups, or any other way to measure candidates, e.g., average of grades in each group. Then, the process comprises computing a percentage of good grades in each group and selecting the group with the highest percentage of good grades as the “reference group”.

Then, comparing the percentage of good grades, or averaged grades in each group to the corresponding percentage in the reference group. Then, the method comprises executing a statistic test or method to compute a difference between the groups. Then, the method determines whether the computed difference is defined as a significant difference or not.

The processes described above are performed by a computerized system or device, for example a server, a laptop, a tablet computer, a personal computer. The computerized system or device comprises a processor that manages the processes. The processor may include one or more processors, microprocessors, and any other processing device. The processor is coupled to the memory of the computerized system or device for executing a set of instructions stored in the memory.

The computerized system or device comprises a memory for storing information. The memory may store a set of instructions for performing the methods disclosed herein. The memory may also store the candidates’ data, the training set, the test set, rules for building the software model and the like. The memory may also store rules for moving the radar, for example moving along the rail or moving using an arm, based on an event, or based on data extracted from the radar’s measurements. The memory may store data inputted by a user of the computerized system or device, such as commands, preferences, information to be sent to other devices, and the like. The computerized system or device may also comprise a communication unit for exchanging information with other systems/devices, such as servers from which the candidates’ data is extracted.

While the invention has been described with reference to exemplary embodiments, it will be understood by those skilled in the art that various changes may be made, and equivalents may be substituted, for elements thereof without departing from the scope of the invention. In addition, many modifications may be made to adapt a particular situation or material to the teachings without departing from the essential scope thereof. Therefore, it is intended that the invention not be limited to any particular embodiment disclosed herein.

1. A computerized method for removing bias when matching job candidates to open positions, the method comprising:
obtaining candidates’ data in a computerized memory, said comprising information about the job candidates and a likelihood rate that the candidate matches the open position;
identifying protected characteristics from the candidates’ data;
generating a training data set that does not bias within groups of candidates having different protected characteristics, wherein generating the training data set comprises
obtaining the candidates’ data, and
removing candidates having a negative score from the candidates’ data according to a group of the candidates,
wherein the training data set includes groups having multiple candidates having positive or negative scores defining positive rates of each group, wherein the groups have similar positive rates;
training a model based on the training data set;
applying the trained model on a test set, wherein the test set is different from the training data set, wherein the trained model receives candidates’ data and outputs a matching or relevance score to the candidates for a specific job; and
determining a fairness measurement value of the trained model using the results of the model on the test set and protected characteristics of candidates of the test set.

2. The method of claim 1, further comprising computing a number of candidates having a negative score to be removed from the candidates’ data when creating the training data set to match a target positive rate among the groups.

3. The method of claim 2, wherein the number of negative examples is computed to substantially equal grades between the groups of candidates defined by the protected characteristics.

4. The method of claim 2, wherein the number of negative examples is computed to substantially equal positive rates among the groups of candidates defined by the protected characteristics, wherein the positive rates define that the candidate is likely to match to the open position.

5. The method of claim 4, wherein the positive rates among groups differ in a value lower than a predefined threshold.

6. The method of claim 1, further comprising defining groups of the candidates based on the identified protected characteristics.

7. The method of claim 1, further comprising enriching the candidates’ data by adding features to the candidates’ data.

8. The method of claim 1, wherein the protected characteristics comprise at least one of a group comprising age, gender, ethnicity, disabilities and a combination thereof.

9. The method of claim 1, wherein determining a fairness measurement value of the trained model further comprising:
providing grades to candidates’ applications in the test set;
dividing the candidates’ applications in the test set to groups according to the protected characteristics; and
applying a statistical test of difference in % of the grades among the groups.

10. The method of claim 1, wherein determining a fairness measurement value of the trained model further comprising removing confounders effect from the test set.

11. A system for removing bias when matching job candidates to open positions, the system comprising a memory and at least one electronic processor that executes instructions to perform actions comprising:
obtaining candidates’ data comprising information about the job candidates and a likelihood rate that the candidate matches the open position;
identifying protected characteristics from the candidates’ data;
generating a training data set that does not bias within groups of candidates having different protected characteristics, wherein the generating training data set comprises
obtaining the candidates’ data, and
removing candidates having a negative score from the candidates’ data according to a group of the candidates,
wherein the training data set includes groups having multiple candidates having positive or negative scores defining positive rates of each group, wherein the groups have similar positive rates;
training a model based on the training data set;
applying the trained model on a test set, wherein the test set is different from the training data set, wherein the trained model receives candidates’ data and outputs a matching or relevance score to the candidates for a specific job; and
determining a fairness measurement value of the trained model using the results of the model on the test set and protected characteristics of candidates of the test set.

12. The system of claim 11, wherein the actions further comprise: providing grades to candidates’ applications in the test set;
dividing the candidates’ applications in the test set to groups according to the protected characteristics; and
applying a statistical test of difference in % of the grades among the groups.

13. The system of claim 11, wherein the actions further comprise computing a number of negative examples to be removed from the candidate’s data when creating the training data set.

14. The system of claim 13, wherein the number of negative examples is computed to substantially equal grades between the groups of candidates defined by the protected characteristics.

15. The system of claim 13, wherein the number of negative examples is computed to substantially equal positive rates among the groups of candidates defined by the protected characteristics, wherein the positive rates define that the candidate is likely to match to the open position.

16. The system of claim 15, wherein the positive rates among groups differ in a value lower than a predefined threshold.
